(19) United States
(12) Patent Application Publication
(10) Pub. No.: US 2013/0126727 A1
(43) Pub. Date: May 23, 2013

(54) Time-of-Flight Electron Energy Analyzer

(71) Applicants: Christopher Jozwiak, Oakland, CA (US); Zahid Hussain, Orinda, CA (US); Alessandra Lanzara, Piedmont, CA (US); Gennadi V. Lebedev, Petaluma, CA (US); Andreas K. Schmid, Berkeley, CA (US); Nord C. Andresen, Berkeley, CA (US); Jeff Graf, Palo Alto, CA (US)

(72) Inventors: Christopher Jozwiak, Oakland, CA (US); Zahid Hussain, Orinda, CA (US); Alessandra Lanzara, Piedmont, CA (US); Gennadi V. Lebedev, Petaluma, CA (US); Andreas K. Schmid, Berkeley, CA (US); Nord C. Andresen, Berkeley, CA (US); Jeff Graf, Palo Alto, CA (US)

(73) Assignee: The Regents of the University of California, Oakland, CA (US)

(21) Appl. No.: 13/389,784

(22) PCT Filed: Jun. 29, 2010
(86) PCT No.: PCT/US10/40399

§ 371 Date: Jun. 7, 2012

Related U.S. Application Data
(60) Provisional application No. 61/232,900, filed on Aug. 11, 2009.

(51) Int. Cl. H01J 49/44

(52) U.S. Cl. CPC H01J 49/446
USPC 250/305

(57) ABSTRACT

A time-of-flight (TOF) photoemission electron energy analyzer includes a TOF spectrometer for measuring an energy spectrum of a beam of electrons photoemitted from a sample and a 90 degree bend bandpass filter for spatially dispersing and filtering electrons according to energy. An exchange scattering electron spin polarimeter for detecting the spin of electrons includes an entrance aperture for admitting an electron beam, a magnetizable target positionable for receiving the electron beam at an angle relative to a target surface normal vector, a pair of Helmholtz coils positioned about the target for magnetizing the target in a selected direction, and a high-speed multi-channel plate (MCP) detector facing toward the target for receiving electrons reflected from the target surface, the MCP outputting a signal corresponding to the spin dependent intensity and time of electrons' arrivals.

### CROSS REFERENCE TO RELATED APPLICATIONS

This application claims priority to PCT Application PCT/US2010/040399, filed Jun. 29, 2010, which in turn claims priority to U.S. Provisional Application Ser. No. 61/232,900 filed Aug. 11, 2009, which applications are incorporated herein by reference as if fully set forth in their entirety.

### STATEMENT OF GOVERNMENTAL SUPPORT

The invention described and claimed herein was made in part utilizing funds supplied by the U.S. Department of Energy under Contract No. DE-AC02-05CH11231. The government has certain rights in this invention.

### BACKGROUND OF THE INVENTION

1. Technical Field

This disclosure relates to electron energy spectroscopy. In particular, this disclosure relates to a system and method for angle resolved photoemission spectroscopy and spin-and-angle resolved photoemission spectroscopy using photoelectron time-of-flight for energy analysis and low energy exchange-scattering with a magnetic thin film for spin analysis.

2. Background

Angle-resolved photoemission spectroscopy (ARPES) has become an important and productive technique in the study of solid state physics. ARPES provides a direct experimental probe of the basic physics of conventional materials and complex and advanced correlated materials. The basic principle of the technique is the photoelectric effect: the sample under study is illuminated by photons which have high enough energy to excite electrons out of the solid, and the angular and energy distributions of these electrons are measured. This technique has been around for many decades. However, in the last 10 years, the development of hemispherical analyzers, which allow collecting the photoelectrons with very high efficiency, has allowed much improved resolutions. These analyzers make use of a spatially resolved detector which provides 2-dimensional data collection of photoelectron dispersion in two spatial dimensions to measure multiple angles and energies simultaneously. This enables mapping of the energy and momentum distributions of photoelectrons with greatly improved efficiency and resolution.

The development of pulsed laser sources, such as those used in time-resolved pump-probe experiments, has made the time-of-flight (TOF) spectrometer an attractive alternative choice for instrumentation rather than the more common hemispherical analyzer. A time-of-flight (TOF) based spectrometer provides an additional 1 dimension of simultaneous data collection through temporal (rather than spatial) dispersion of the photoelectron energy spectrum. Measuring the TOF of the photoelectron determines the velocity, and hence the energy of the photoelectron. The concept of TOF spectroscopy has been used for many decades in the fields of mass spectroscopy and neutron spectroscopies, but has not been used as heavily for electron spectroscopies, mainly due to the success of the hemispherical analyzers with quasi-continuous wave light sources. The first example of using the TOF technique for photoemission spectroscopy is found by Bachrach in 1975 (J. Vac. Sci. Technol. 12, 309). An improvement of this system with a retarding focusable lens system is found in Hemmers et al., Rev. Sci. Instr. 69, 3809 (1998).

Previous TOF electron spectrometers are characterized by a single straight flight path, which requires that the total flight-time width of the entire emitted electron spectrum (difference in flight times between slowest and fastest electrons) is less than the time window between excitation pulses. This aspect (as described below) poses a limit on the energy resolution for a given time period between excitation pulses provided by such spectrometers. The conventional commercial spectrometers are targeted mainly to be used with ultra-low energy laser systems currently being used for photoemission experiments (6-7 eV) that emit very narrow total electron spectra which can be measured with high resolution in these instruments. However, certain pulsed photon sources such as the Advanced Light Source 2-bunch mode (at Lawrence Berkeley National Laboratory), proposed future High Harmonic Generation (HHG) lasers and Free-Electron Lasers (FELs), can have much higher photon energies, and result in wider total energy range. Photoemission spectra measurements with these instruments would require reduced energy resolution. There is a need, therefore, for improved resolution at higher photon energies, where photoelectrons have a wide energy distribution.

It is also understood that ARPES can be extended to probe directly the spin degree of freedom in materials, referred to as spin-ARPES. However, development of this technique has lagged behind that of standard ARPES. Development of Instrumentation capable of measuring the additional spin resolution has not advanced as quickly as conventional ARPES instruments, slowing the development of spin-ARPES. There is currently a growing need for a direct and accurate spin-sensitive probe in condensed matter physics and advanced materials sciences. This need is motivated by interest in complex magnetic systems and the increasing need of advanced materials for data storage, advanced processing, and new magnetic materials for “spintronics” based applications.

Spin-ARPES is a promising technique to aid research in developing new materials for such applications. Current experiments are conventionally performed by combining a hemispherical analyzer with current state-of-the-art spin-polarimeters, which are usually various implementations of the so-called “Mott-polarimeter”. However, because of the electron collection efficiencies of each of these implementations, the combination of these two instruments makes spin-ARPES a very slow and difficult technique with less energy and angle resolution than regular ARPES experiments. Here, the “spin-resolving power” is set by the magnitude of the spin scattering asymmetry which is determined by the spin-orbit effect. This is a relativistic effect, so reasonable resolving powers are only achieved at very high kinetic energies of 20-100 keV. The total efficiency of the polarimeter is given by both the spin-resolving power and the total collected reflectivity. At the high kinetic energies in this scheme, the reflectivity is extremely low, resulting in overall low total efficiency. Total polarimeter efficiency is quantified by a Figure of Merit (FOM) which in the case of current state-of-the-art Mott-polarimeters is below 2×10⁻⁴.

### SUMMARY OF THE INVENTION

The present disclosure describes a TOF spectrometer which can be used for taking high energy resolution spectra not only with the 6-7 eV pulsed laser systems, but also for any light source such as the Advanced Light Source 2-bunch mode and future HHG lasers and FELs with photon energies up to near 1 keV. Having flexibility in changing photon energy through a wide range is an important aspect in many current ARPES systems. However, obtaining high resolution at higher energies is a challenge.

The disclosed spectrometer achieves this high resolution with a 90 degree bandpass filter which can target the region of interest in an emitted spectrum, and measure it with higher energy resolution, while removing the unwanted portions of the spectrum. This new combination of TOF and 90 degree bandpass filter apparatus and technique enable ARPES measurements using pulsed laser, HHG laser, pulsed synchrotron, and FEL light sources. When used with such light sources, new possibilities for studying ultra-fast properties of condensed matter with ARPES are possible.

Driven by the growing need for an experimental tool that can measure the spin degrees of freedom, a new spectrometer is disclosed which will allow performing spin-ARPES experiments with 100 times more efficiency than current conventional instruments. The disclosed apparatus and technique allows spin-ARPES to operate near the same resolution ranges in which regular ARPES measurements are currently performed by combining a TOF-based electron energy analyzer with a new exchange scattering-based spin-polarimeter which is 10-100 times more efficient than the currently used Mott-polarimeters. The spin-ARPES (S-ARPES) spectrometer will function overall with better than 100 times more efficiency than the current state-of-the-art techniques (e.g., hemispherical analyzer plus Mott detector). This increase in efficiency directly translates into increased energy and angle resolutions with which the spin-ARPES experiments can be performed. Thus, the disclosed instrumentation can advance the field of spin-dependent solid state physics.

The spin polarimeter is based on low kinetic energy exchange scattering (as opposed to spin-orbit scattering relied upon in the Mott-polarimeter) using a ferromagnetic thin-film scattering target. An electron beam whose spin polarization is to be analyzed is retarded to low kinetic energy (<10 eV), directed through the spin polarimeter aperture and focused onto the surface of the ferromagnetic thin-film target. A large percentage (˜1%) of the beam is elastically reflected from the surface and then recorded by a multi-channel plate (MCP) detector. This average reflectivity is higher than the Mott-polarimeter average reflectivity. Sensitivity is highest when the reflected electrons are specular, i.e., the angle of reflection equals the angle of incidence. The exact percentage of electrons reflected is dependant on the relative alignment of the spin of the electron beam and the magnetization direction of the target. Comparing measurements with the target magnetized in opposite directions yields the polarization of the incident beam. The relevant physics is described in J. Graf et. al, Phys. Rev. B 2005 and references therein. To prevent interference from contamination or reactivity after the ferromagnetic thin-film target is prepared, the film is preferably deposited in situ under ultra-high vacuum in a chamber 2050 enabling preparation and use of the ferromagnetic thin-film target 2010.

The spin-polarimeter disclosed comprises a thin-film ferromagnetic scattering target. The reflectivity of electrons from the ferromagnetic thin-film target 2010 depends on the spin orientation of the incident electrons relative to the magnetization of the ferromagnetic thin-film target. Spin analysis is performed through the comparison of spectra taken with the scattering target magnetized in opposite directions. The low kinetic energy of the scattering process (<10 eV) results in much larger average reflectivity than found at the high energy scattering process (typically 20-100 keV) of “Mott-polarimeters”.

The actual detection is performed as a single electron counting event by a circular high-speed MCP 2030. The fast electron signal rise-times (<1 ns) allows timing resolution of electron arrivals to ˜100 ps. This timing resolution allows the polarimeter to be used in time-resolved studies or to be coupled to devices such as the TOF electron energy analyzer. The spin-polarimeter 2000, in combination with a TOF electron energy spectrometer 1000 may provide large efficiency enhancements for spin resolution over current conventional instruments.

To summarize, disclosed is (a) a TOF photoemission spectrometer with an electron beam bandpass filter, (b) an exchange-scattering electron spin polarimeter, and (c) a TOF photoemission spectrometer combined with an exchange scattering electron spin polarimeter.

### BRIEF DESCRIPTION OF THE DRAWINGS

In the drawings, wherein like reference numerals refer to similar components:

FIG. 1 schematically illustrates a time-of-flight photoemission electron spectrometer with a band-pass filter, in accordance with the invention;

FIG. 2 schematically illustrates a spin polarimeter in accordance with the invention;

FIG. 3 shows an embodiment of a spin-polarimeter, in accordance with the invention;

FIG. 4 shows an embodiment of a time-of-flight exchange scattering spin-and-angle-resolved photoemission spectrometer, in accordance with the invention.

### DETAILED DESCRIPTION OF THE PREFERRED EMBODIMENTS

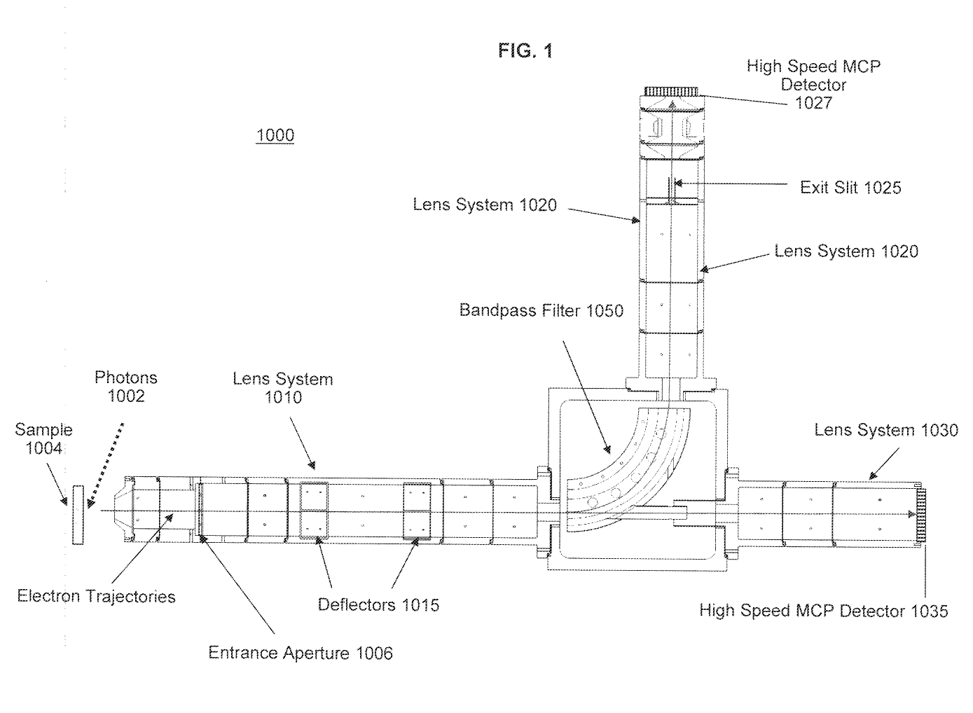

FIG. 1 schematically illustrates a time-of-flight photoemission electron spectrometer with a band-pass filter (TOF/BPF) 1000, in accordance with the invention. Photons 1002 irradiate a sample 1004 being investigated. The sample may be, for example, a metal with a work function. According to Einstein's photoelectric effect, if the energy hv of a photon 1002 of frequency v incident on an electronic material sample 1004 is larger than the electronic work function Φ, electrons may be ejected with a spectrum of energies up to a maximum energy

Eₘₐₓ=hv−Φ

where h is Planck's constant. The surface-parallel component of electron momentum within the sample 1004 before ejection and after emission from the sample is conserved. Therefore, a study of the emission energy versus angle of emission is a tool to study the electronic band structure of the sample 1004.

The photons 1002 are incident on the sample 1004 in short pulses, resulting in pulsed emission of photoemitted electrons, which enter the TOF/BPF 1000 at lens system 1010. Deflectors 1015 correct (e.g., deflect) the electron beam path to the center of the lens system 1010 if the sample/photon beam spot are not aligned with the lens system's optical axis. Lens system 1010 may also electrostatically retard the velocity of the photoemitted electrons to shift the energy spectrum downward. A variable entrance aperture 1006 determines the angular acceptance.

The TOF/BPF 1000 may operate in two modes. In one mode, the beam may proceed directly through a band-pass filter to a lens system 1030 on a straight trajectory. Lens system 1030 helps focus the beam onto a final electron detector. The entire electron energy spectrum can be recorded temporally by velocity-time of flight measurement with a high speed detector 1035 to resolve energy, integrating over the entire acceptance angle range. Commercially available MCP-based detectors providing high time- and spatial-resolution used here 1035 can provide improved angular resolution.

In a second mode, a band-pass filter (BPF) 1050 deflects and spatially disperses the electron beam. The BPF 1050 consists essentially of segments of two concentric spherical electrode of different radius, between which a voltage difference is applied to deflect the electron beam through ˜90°. Lower energy electrons, having a lower velocity, will be deflected through a larger change in direction (>90°). Higher energy electrons will be deflected less (<90°). Thus, the electron beam will be spatially dispersed according to energy. The electron beam enters a lens system 1020. Lens system 1020 may also electrostatically retard or accelerate the velocity of the photoemitted electrons to shift the energy spectrum downward or upward, as well as refocus the beam into the final detector (in this case a spin-polarimeter) at the desired kinetic energy. A variable exit slit 1025 can reject an unwanted portion of the spectrum, for example, outside a selected energy band, and allow a narrower portion of the spectrum to pass through to detection. Varying the voltage between the two electrodes of the BPF 1050 and varying the entrance aperture 1006 and the exit slit 1025 dimension determine the range of energies of the photoemitted electrons which are passed through to a final detector, and the photoemitting sample's orientation with respect to the lens system 1010 determines the momentum values of the electrons in the sample plane.

To enable the TOF/BPF 1000 to measure the entire spectrum via lens system 1030, the voltage applied to the plates of the BPF 1050 is turned off, and an straight-through hole in the outer concentric electrode permits the electron beam to pass into the lens system 1030.

To measure the energy spectrum in a TOF photoemission system, in addition to the sample and a pulsed excitation source, all that is required is a drift space followed by a high-speed electron detector. Energy resolution is provided by precise measurement of the time between an excitation pulse (tₛₜₐᵣₜ) and ultimate electron detection (tₛₜₒₚ). Angular resolution is provided by the system's angular acceptance, defined by an explicit aperture along the flight path or simply by the size of the detector. The kinematic relationship between electron kinetic energy and flight time is given by

$${E}_{k} = \frac{1}{2} {m}_{e} {V}^{2} = \frac{1}{2} m \frac{{L}^{2}}{{t}^{2}}$$

where t is the flight time given by tₛₜₒₚ−tₛₜₐᵣₜ and L is the length of the electron flight path. The distribution of photoelectron kinetic energies is measured as a distribution of flight times.

It can be shown that the energy measurement resolution of photoemitted electrons is given by

$$\frac{Δ E}{{E}_{k}} = 2 \sqrt{\frac{2}{{m}_{e}}} \frac{1}{L} \sqrt{{E}_{k}} Δ t$$

This result shows that the TOF resolving power is dependent on the kinetic energy of the photoelectron being analyzed and the time resolution, Δt. Thus the resolving power improves for lower energy and faster detection timing. Hence, there is strong motivation to provide a spectroscopic technique that functions at lower electron flight energies to improve resolution.

The research and development of new magnetic materials has become of central importance. Keys to these aims are electron spin sensitive instruments for directly probing the spin degree of freedom in materials both new and old concurrently with electronic energy studies.

Disclosed is a technique and system for measuring spin polarization with a figure-of-merit FOM on the order of 10⁻² (˜100 times better than the current “Mott-polarimeter” technologies). This large improvement in efficiency could greatly enhance any measurement of spin polarization such as spin-resolved electron energy loss spectroscopy (SPEELS), spin-resolved scanning electron microscopy (Spin-SEM or SEMPA), and spin-resolved photoemission electron spectroscopy (spin-PES and spin-ARPES).

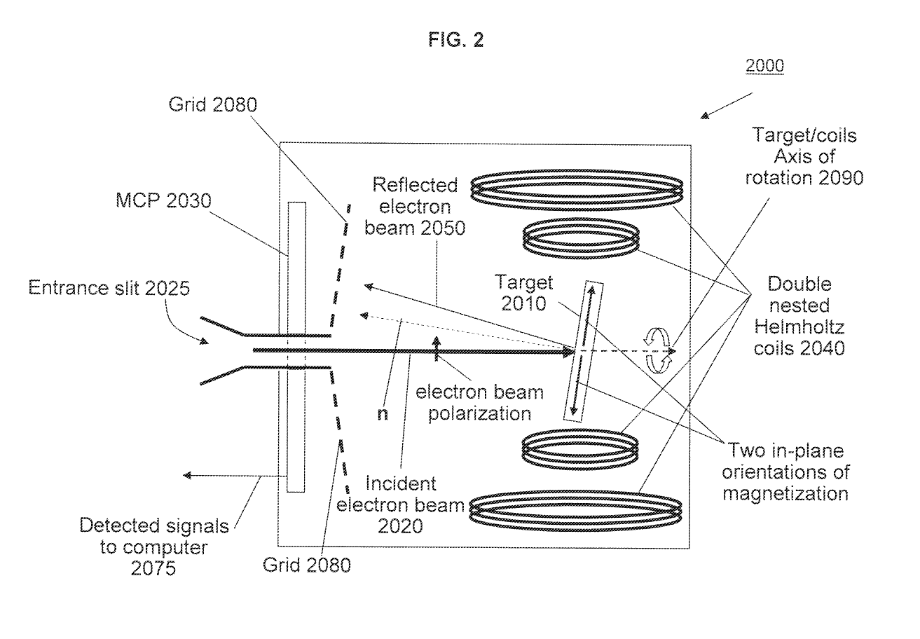

FIG. 2 schematically illustrates elements of a spin polarimeter 2000 based on low kinetic energy exchange scattering using a ferromagnetic thin-film scattering target 2010. An electron beam 2020 whose spin polarization is to be analyzed is retarded to low kinetic energy (<10 eV) and focused onto the surface of the target 2010. A large percentage (˜1%) of the beam is elastically (i.e., specularly) reflected from the surface and then recorded by a circular multi-channel plate detector (MCP) 2030 having a central aperture to pass the electron beam 2020. The exact percentage of electrons reflected is dependant on the relative alignment of the spin of the electron beam and the magnetization direction of the target 2010. Comparing measurements with the target 2010 magnetized in opposite directions yields the polarization of the incident beam. With a high-speed MCP 2030, precise timing information is accessible, allowing the polarimeter to be used in combination with time-resolved instruments such as a TOF photoemission electron energy spectrometer with a 90 degree BPF.

The scattering target is a high-quality ferromagnetic crystal surface. An attached chamber 2050 is included for preparation and growth of numerous crystal surfaces which can be used. A in-situ pair of double nested Helmholtz coils 2040 magnetize the target 2010 into a single domain and an electron count-rate is recorded. The magnetization of the target 2010 can be reversed by the in-situ coils 2040, and the count-rate can be recorded a second time. The difference in count rates is related to the spin-dependent reflectivity of the ferromagnetic target. With a “calibrated” target, the polarization of the incident electron beam can be recorded. The configuration of the double nested Helmholtz coils 2040 includes an outer pair of larger coils that produce a smaller field at the target that is in the opposite direction as the more intense field produced by two inner coils that provide a field large. Thus the magnetizing field at the target 2010 is the difference of the two field intensities. However, outside the two larger coils, the fields tend to cancel, thus minimizing the possibility of magnetization of any surrounding components.

The target 2010 and double nested Helmholtz coils 2040 may be rotated as a single structure about an axis 2090 coincident with the incoming electron beam, which affords an additional degree of freedom in orienting the magnetization of the target 2010.

A grid 2080 placed close to the MCP 2030 may be optionally included in the spin polarimeter 2000. The grid 2080 may be used to minimize differences in time of flight to the MCP 2030 due to differences in reflected electron path length with changes in the angular orientations of the target 2010. To minimize the time differences, the grid 2080 may be biased to accelerate the electrons in the small space between the grid 2080 and the MCP 2030, shortening the transit time in this space. The grid may be preferentially shaped as a cone or spherical surface (which is nearly ideal) to equalize the time of flight to the grid and minimize the time to transit further to the MCP 2030.

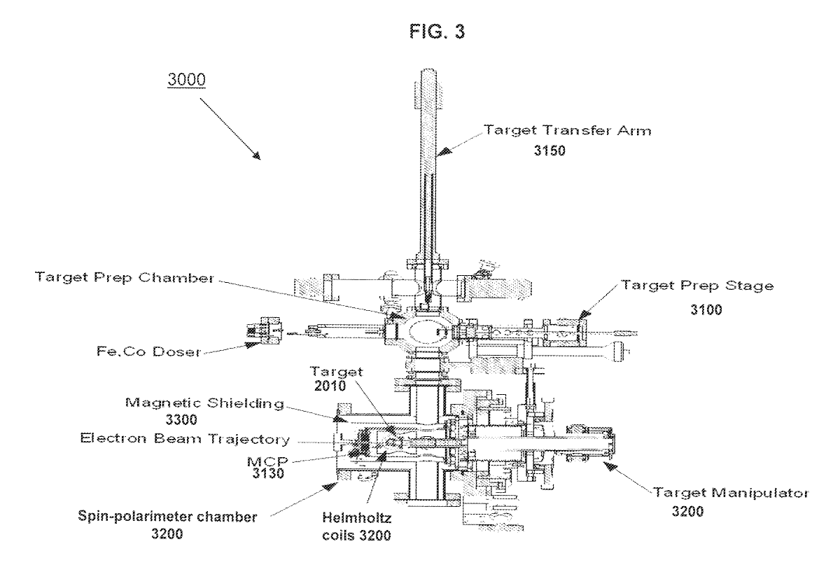

FIG. 3 shows an embodiment of a spin-polarimeter 3000 in detail. Spin-polarimeter 3000 includes a target preparation stage 3100 for deposition of the ferromagnetic thin-film target 2010 on a substrate. The target 2010 is then moved by a target transfer arm 3150 for mounting (in situ) on a target manipulator 3200 for positioning in the trajectory of the incident electron beam. The Helmholtz coils 2040 provide enough field density at the sample to magnetize the target 2010 in the desired in-plane direction. Between the target 2010 and the aperture 2025, a high-speed circular MCP 3130 having a through-hole aperture to admit the electron beam 2020 faces a beam of reflected electrons 2050. The lens system 1020 can focus the incident beam for maximum focusing at the surface of the MCP 3130, to optimize the throughput, or count rate.

Stray electric and magnetic fields are kept to a minimum to allow proper transmission of the low kinetic energy (<10 eV) electron beams. Double-walled magnetic shielding 3300 is used, and only non-magnetic materials and components are used inside of the shielding 3300. The thin-film ferromagnetic target 2010 has only very small stray magnetic fields. The in-situ Helmhotz coils 2040 for target magnetization are two sets of opposed Helmholtz coils which give large enough fields for magnetization localized at the target (˜100 G), but do not create large stray fields which could magnetize other components, in-particular the magnetic shielding 3300.

The actual detection is performed as a single electron counting event by the circular high-speed MCP 3130. The <1 ns electron signal rise-times allows timing resolution of electron arrivals to ˜100 ps. This timing resolution allows the polarimeter to be used in time-resolved studies or be matched with devices such as a time-of-flight (TOF) based electron energy analyzer.

The operation of the polarimeter in a TOF scheme requires the detector assembly to give excellent timing resolution. Integration into a TOF scheme also requires that the possible trajectories introduce minimal variations to the total flight path length.

A TOF spectrometer has the electron energy spectrum disperse through the time dimension, allowing the energy spectrum to be simultaneously recorded with a single spatial channel time-resolved detector. Both the novel spin-polarimeter itself, and its combination with a TOF based energy spectrometer offer large efficiency enhancements over current state-of-the-art instruments. This potent combination then provides a significant improvement in the fields of current spin-ARPES and spindependent solid state physics measurements.

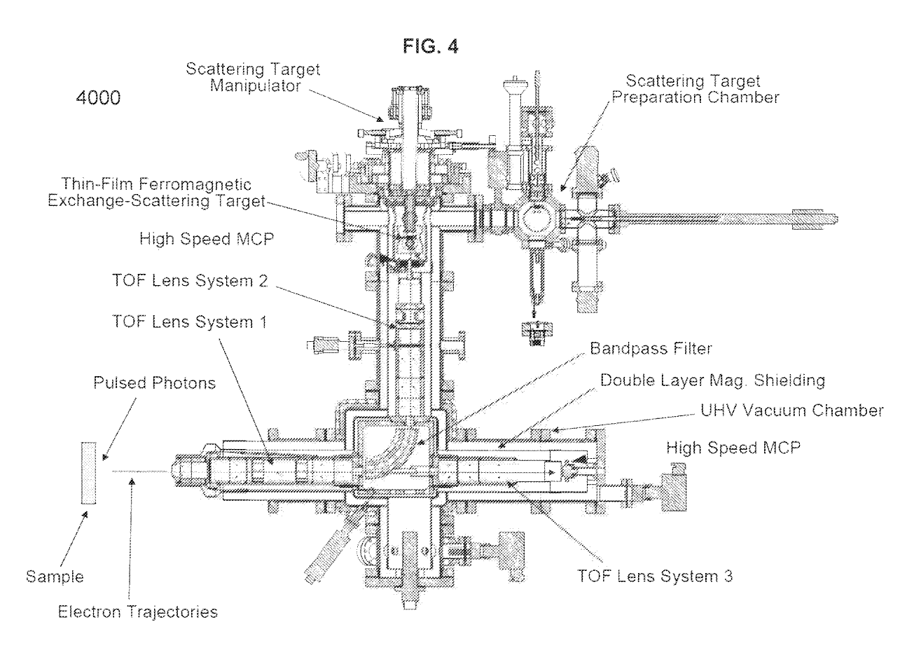

FIG. 4 shows an embodiment of a time-of-flight exchange scattering spin-and-angle-resolved photoemission spectrometer (spin-ARPES) 4000. Referring to FIGS. 1-4, a pulsed photon source excites a sample 1004 in front of the first lens system 1010 of the spin-ARPES 4000. Electrons travel from the sample 1040 through TOF Lens System 1010 and can then either travel straight through TOF Lens System 1030 to be detected by a single-channel (or multi-channel) high speed MCP electron detector 1035, or they can be deflected through the bandpass filter 1050 to TOF Lens System 1020. When using Lens System 1020, the unwanted portion of the spectrum is chopped off by the variable exit slit 1025, and the remaining beam is focused into the spin polarimeter 3000 (FIG. 3). In the spin polarimeter 3000, the electrons are reflected off of the thin film ferromagnetic target 2010, back onto a high speed MCP electron detector 3130. In either case, the MCP electron detectors 1035 or 3130 output a high speed pulse marking the time of electron arrival with 100 ps resolution. These pulses are converted into digital flight times which can be converted into photoelectron energy via time measurement and velocity calculation. For spin-analysis, spectra taken with the scattering target 2010 magnetized in opposite directions are compared, with the difference being proportional to the spin polarization.

The invention, therefore, is not to be restricted except in the spirit of the following claims.

What is claimed is:

1. A time-of-flight (TOF) photoemission electron energy analyzer for measuring a spectrum of kinetic energy of a beam of electrons photoemitted from a sample comprising:
a TOF spectrometer including a first lens system a second lens system and a third lens system;
a 90 degree bend bandpass filter including quadrant sectors of two conducting spherical plates coupled to the TOF spectrometer first second and third lens systems; and
a high-speed multi-channel plate (MCP) detector to receive the photoemitted electrons after reflection from a positionable and magnetizable target.

2. The energy analyzer of claim 1, the TOF spectrometer further comprising:
the first lens system having a central axis to receive and focus the beam of electrons emitted by the sample when illuminated by a source of pulsed photons at a first time, in which the sample has a surface normal vector that is at an angle relative to the central axis, the first lens system also being capable of electrostatically accelerating and/or retarding the kinetic energy of the electrons by a first selected amount;
the second lens system coupled in line to the first lens system to receive and focus the beam of electrons from the first lens system when bypassing the 90 degree bend bandpass filter, the second lens system also being capable of electrostatically accelerating and/or retarding the kinetic energy of the electrons by a second selected amount;
a high speed detector for receiving the electrons from the second lens system at a second time, wherein the path from the sample to the high-speed detector is characterized by a length L, and the time of flight is determined on the basis of a time interval measured between the first time and the second time, and a velocity is determined on the basis of the time interval and the length L.

3. The energy analyzer of claim 2, the 90 degree bend bandpass filter further comprising:
an entrance port coupled to the first lens system;
the 90 degree bend bandpass filter having a potential difference applied between the two concentric spherical conducting plates to bend the electron beam by nominally 90 degrees and to divert and spatially disperse the photoemitted electrons to be filtered according to the kinetic energy; and
an exit port for passing the spatially dispersed photoemitted electrons to the third lens system.

4. The energy analyzer of claim 3 further comprising:
the third lens system coupled to the exit of the 90 degree bandpass filter at 90 degrees to the first lens system for receiving and focusing the spatially dispersed electrons, the third lens system also being capable of electrostatically accelerating and/or retarding the energy of the electrons by a third selected amount; and
an exit slit coupled to the third lens system having a selected aperture to define the allowed trajectories, thereby defining the kinetic energy range of the photoemitted electrons passed by the BPF.

5. The energy analyzer of claim 4, further comprising:
the high-speed multi-channel plate (MCP) detector coupled to the third lens system adapted to receive and measure energy of exiting photoemitted electrons on the basis of a path length L′ and the time of flight from the sample to the MCP detector, and the exit slit aperture.

6. The energy analyzer of claim 5 further comprising a voltage biased grid between the MCP and the target to accelerate the photoemitted electrons, thereby adjusting the time-of-flight for path length L′ differences due to changes of an angular position of the target.

7. An exchange scattering electron spin polarimeter for detecting the spin of electrons in a beam comprising:
an entrance aperture for admitting an electron beam;
a magnetizable target positionable for receiving the electron beam at an angle relative to a surface normal vector of the target;
a pair of Helmholtz coils positioned about the target for magnetizing the target in a selected direction; and
a high-speed multi-channel plate (MCP) detector facing toward the target for receiving electrons reflected from the target surface, the MCP having an aperture to admit and pass the electron beam incident from the entrance slit, the MCP outputting a signal corresponding to a spin-dependent intensity and time of arrival of the electrons received.

8. A time-of-flight exchange scattering spin-and-angle-resolved photoemission electron energy analyzer for measuring a spectrum of kinetic energy and spin orientation of a beam of electrons photoemitted from a sample comprising:
a TOF electron photoemission spectrometer having a first lens system, a second lens system, a third lens system, and a high speed multi-channel plate (MCP) detector coupled to the second lens system;
an electron energy bandpass filter (BPF), wherein the BPF is coupled to a first lens system receiving a beam of photoemitted electrons having a spectrum of energies, a second lens system for receiving a beam of electrons from the first lens system by passing straight through the BPF, and a third lens system for receiving electrons from the BPF, the electrons being deflected nominally at 90 degrees and spatially dispersed by the BPF according to energy; and
an exchange scattering electron spin polarimeter coupled to the third lens system for measuring an orientation of spin of the electrons after reflection from a positionable magnetizable target.

9. The analyzer of claim 8, further comprising a sample illuminated by a beam of photons of a selected energy, wherein the sample has a surface normal, the sample being positioned with the surface normal directed at an angle with respect to a central axis of the first lens system.

10. A time-of-flight (TOF) photoemission electron energy analyzer for measuring a spectrum of kinetic energy and spin polarization of a beam of electrons photoemitted from a sample comprising:
a TOF spectrometer including a first lens system a second lens system and a third lens system;
a 90 degree bend bandpass filter coupled to the TOF spectrometer first second and third lens systems for spatially, diverting, dispersing and filtering the photoemitted electrons from the first lens system into the third lens system according to the kinetic energy of the photoemitted electrons;
An exchange scattering electron spin polarimeter coupled to the third lens system for detecting the spin of electrons in a beam comprising:
an entrance aperture for admitting an electron beam;
a magnetizable target positionable for receiving the electron beam at an angle relative to a surface normal vector of the target;
a pair of Helmholtz coils positioned about the target for magnetizing the target in a selected direction; and
a high-speed multi-channel plate (MCP) detector facing toward the target for receiving electrons reflected from the target surface, the MCP having an aperture to admit and pass the electron beam incident from the entrance aperture (slit?), the MCP outputting a signal corresponding to a spin-dependent intensity and time of arrival of the electrons received.

11. The analyzer of claim 10, further comprising a sample illuminated by a beam of photons of a selected energy, wherein the sample has a surface normal, the sample being positioned with the surface normal directed at an angle with respect to a central axis of the first lens system.

12. The analyzer of claim 10, the TOF spectrometer further comprising:
the first lens system having a central axis to receive and focus the beam of electrons emitted by the sample when illuminated by a source of pulsed photons at a first time, in which the sample has a surface normal vector that is at an angle relative to the central axis, the first lens system also being capable of electrostatically accelerating and/or retarding the kinetic energy of the electrons by a first selected amount;
the second lens system coupled in line to the first lens system to receive and focus the beam of electrons from the first lens system when bypassing the 90 degree bend bandpass filter, the second lens system also being capable of electrostatically accelerating and/or retarding the kinetic energy of the electrons by a second selected amount;
a high speed detector for receiving the electrons from the second lens system at a second time, wherein the path from the sample to the high-speed detector is characterized by a length L, and the time of flight is determined on the basis of a time interval measured between the first time and the second time, and a velocity is determined on the basis of the time interval and the length L.

13. The energy analyzer of claim 12, the 90 degree bend bandpass filter further comprising:
an entrance port coupled to the first lens system;
a 90 degree sector of two concentric spherical conducting plates disposed between the first lens system and the second lens system, the two plates having an applied potential difference to bend the electron beam by nominally 90 degrees and to spatially disperse the photoemitted electrons to be filtered according to the kinetic energy; and
an exit port for passing the spatially dispersed photoemitted electrons to the third lens system.

14. The energy analyzer of claim 13 further comprising:
the third lens system coupled to the exit of the 90 degree bandpass filter at 90 degrees to the first lens system for receiving and focusing the spatially dispersed electrons, the third lens system also being capable of electrostatically accelerating and/or retarding the energy of the electrons by a third selected amount; and
an exit slit coupled to the third lens system having a selected aperture to define the allowed trajectories, thereby defining the kinetic energy range of the photoemitted electrons passed by the BPF.

15. The energy analyzer of claim 14, further comprising:
a high-speed multi-channel plate (MCP) detector coupled to the third lens system adapted to receive and measure the energy of exiting photoemitted electrons on the basis of a path length L′ and the time of flight from the sample to the MCP detector, and the exit slit aperture.

16. The energy analyzer of claim 15 further comprising a voltage biased grid between the MCP and the target to accelerate the photoemitted electrons, thereby adjusting the time-of-flight for path length L′ differences due to changes of an angular position of the positionable magnetizable target.

17. A method of measuring a spectrum of kinetic energy and spin polarization of a beam of electrons photoemitted from a sample comprising:
directing the beam of photoemitted electrons through a time-of-flight (TOF) photoemission electron energy and spin analyzer, wherein the analyzer includes a TOF spectrometer, the TOF spectrometer including a first lens system, a second lens system, a third lens system, and a 90 degree bend bandpass filter coupled to the TOF spectrometer first, second and third lens systems;
diverting, dispersing and filtering the photoemitted electrons from the first lens system into the third lens system from the 90 degree bend bandpass filter according to the kinetic energy of the photoemitted electrons;
admitting the electron beam from the third lens system through an exit slit to an entrance aperture;
positioning a target to have a surface normal vector at an angle to the admitted electron beam;
magnetizing the target in a selected direction with a pair of Helmholz coils;
receiving the admitted electron beam from the entrance aperture at the magnetizable target surface;
receiving electrons reflected from the target surface at a high-speed multichannel plate (MCP) detector facing toward the target, wherein the MCP has an aperture to admit and pass the electron beam incident from the entrance aperture; and
outputting from the MCP a signal corresponding to a spin-dependent intensity and time of arrival of the electrons received.

18. A method of detecting spin polarization of a beam of electrons photoemitted from a sample comprising:
admitting the electron beam through an entrance aperture;
positioning a target to have a surface normal vector at an angle to the admitted electron beam;
magnetizing the target in a selected direction with a pair of Helmholz coils;
receiving the admitted electron beam from the entrance aperture at the magnetizable target surface;
receiving electrons reflected from the target surface at a high-speed multichannel plate (MCP) detector facing toward the target, wherein the MCP has an aperture to admit and pass the electron beam incident from the entrance aperture; and
outputting from the MCP a signal corresponding to a spin-dependent intensity and time of arrival of the electrons received.
